(19) United States
(12) Patent Application Publication
(10) Pub. No.: US 2023/0237394 A1
(43) Pub. Date: Jul. 27, 2023

(54) INTELLIGENT MANAGEMENT METHOD AND SYSTEM FOR ORGANIZATIONAL STRUCTURE, AND MEDIUM

(71) Applicant: Qingdao Zhenyou Software Technology Co., Ltd., Qingdao (CN)

(72) Inventor: Kefeng Zhu, Guangzhou (CN)

(73) Assignee: Qingdao Zhenyou Software Technology Co., Ltd., Qingdao (CN)

(21) Appl. No.: 17/690,024

(22) Filed: Mar. 9, 2022

(30) Foreign Application Priority Data
Jan. 26, 2022 (CN) 202210092251.1

(51) Int. Cl. G06Q 10/06; G06Q 10/10

(52) U.S. Cl. CPC G06Q 10/06311; G06Q 10/10

(57) ABSTRACT

An intelligent management method for an organizational structure method includes: acquiring part-time request information of a first target person (including a part-time role to be taken by the first target person and a first target department to which the part-time role belongs); acquiring an organizational structure of a target company to which the first target person belongs (including N departments having a tree-like hierarchy); when a first department in the N departments is identical to the first target department, assigning the part-time role to the first department, and updating the organizational structure; or when no department identical to the first target department exists in the N departments, determining a superior department of the first target department; and adding, based on the superior department, the first target department as a part-time department to the organizational structure, and updating the organizational structure; and outputting an updated organizational structure.

### CROSS REFERENCE TO THE RELATED APPLICATIONS

This application is based upon and claims priority to Chinese Patent Application No. 202210092251.1, filed on Jan. 26, 2022, the entire contents of which are incorporated herein by reference.

### TECHNICAL FIELD

The present invention relates to the technical field of office automation management, and more particularly, to an intelligent management method and system for an organizational structure, and a medium.

### BACKGROUND

With the development of society, different organizations (e.g., departments) may emerge in companies or government agencies. Therefore, it is necessary to manage different organizations.

Currently, the management of an organizational structure is mainly based on staffing management. However, in the conventional organizational structure management, when people work together across organizations, each organization is relatively independent in terms of approval and assessment relationships. This leads to the problem of lack of interoperability between organizations, which causes difficulty in flat management of organization staff and fails to effectively realize office automation management.

### SUMMARY

On this basis, an objective of the present invention is to provide an intelligent management method and system for an organizational structure, and a medium, for flat management of organization personnel, so as to realize office automation management.

According to a first aspect, embodiments of the present invention provide an intelligent management method for an organizational structure, including:

acquiring part-time request information of a first target person, wherein the part-time request information includes a part-time role to be taken by the first target person and a first target department to which the part-time role belongs;

acquiring an organizational structure of a target company to which the first target person belongs, wherein the organizational structure includes N departments of the target company, the N departments have a tree-like hierarchy, and N is an integer greater than or equal to 2;

determining whether a department identical to the first target department exists in the N departments;

if it is determined that a first department in the N departments is identical to the first target department, assigning the part-time role to the first department, and updating the organizational structure; or if it is determined that no department identical to the first target department exists in the N departments, determining a superior department of the first target department; and adding, based on the superior department, the first target department as a part-time department to the organizational structure, and updating the organizational structure; and

outputting an updated organizational structure.

In the technical solution provided by the embodiments of the present invention, by adding part-time information (part-time role and part-time department) to an organizational structure of a target company, department combinations in the organizational structure are more diverse and visible, and the relationship between staff and departments in the organizational structure is clear and visible, which facilitates information management of the organizational structure, and the organizational structure can be adjusted flexibly, so that during scheduling of department staff, cross-department review (approval and/or assessment) can be implemented, to facilitate flat management of staff in various departments, thereby effectively realizing office automation management. In addition, when there is no expert department system in the target company, a temporary system can be established by creating a part-time department, so that expert staff can take part-time position roles of multiple departments to provide guidance.

In a possible design, the organizational structure further includes a personnel review relationship corresponding to any department in the organizational structure, the personnel review relationship is an approval relationship or assessment relationship in the any department, and the personnel review relationship includes a reviewer role and a reviewee role in a review process node; and

the step of assigning the part-time role to the first department and updating the organizational structure includes:

planning a role of the part-time role in the personnel review relationship corresponding to the first department, and updating the organizational structure.

In a possible design, before the step of adding, based on the superior department, the first target department as the part-time department to the organizational structure, and updating the organizational structure, the method further includes:

defining the part-time role as a reviewer role in the personnel review relationship corresponding to the first target department.

In a possible design, any department in M departments is an inherent main department or part-time department in the organizational structure of the target company, the M departments include the N departments, or include the N departments and the first target department; and the method further includes:

acquiring review request information sent by a second target person in the target company, wherein the review request information is approval request information or assessment information, and the review request information comprises identification information of the second target person;

acquiring a personnel review relationship corresponding to the M departments;

determining, based on the personnel review relationship corresponding to the M departments, L departments to which the second target person belongs and respective reviewer roles in the L departments, where L is an integer greater than or equal to 1;

traversing a tree-like hierarchy among the M departments, and determining respective upper-level departments corresponding to the L departments and respective reviewer roles in the upper-level departments;

sorting, based on a hierarchical relationship between the L departments and the upper-level departments, respective reviewer roles corresponding to the L departments and the respective reviewer roles in the upper-level departments in an ascending hierarchical order to obtain a hierarchical reviewer role sorting relationship; and

reviewing the review request information level by level based on the hierarchical reviewer role sorting relationship.

In a possible design, before the step of reviewing the review request information level by level based on the reviewer role sorting relationship, the method further includes:

if reviewer roles of any level in the hierarchical reviewer role sorting relationship include at least two identical reviewer roles, reserving one of the at least two reviewer roles in a review process, and deleting the rest of the at least two reviewer roles.

In the embodiments of the present invention, reviewer roles of different levels corresponding to the second target person are sorted hierarchically and perform reviewing level by level, which facilitates flat management of the review process of department staff, thereby effectively realizing office automation management.

In a possible design, the method further includes:

acquiring assistance request information of a second target department in the M departments, wherein the assistance request information includes the number of assistants required by the second target department;

determining respective surplus labor of departments other than the second target department in the M departments to obtain X third target persons, where X is an integer greater than or equal to 1; and

picking up third target persons with the number of assistants required from the X third target persons to serve as the assistants of the second target department.

In a possible design, before the step of picking up the third target persons with the number of assistants required from the X third target persons to serve as the assistants of the second target department, the method further includes:

if the X third target persons include a plurality of identical third target persons, reserving one of the plurality of third target persons, and deleting the rest of the plurality of third target persons.

In the embodiments of the present invention, surplus labor in a department can be lent to other departments in the form of part-time labor, and department staff can be scheduled flexibly, which can improve the utilization of staff and effectively realize office automation management.

According to a second aspect, the embodiments of the present invention further provide an intelligent management system, including:

a receiving unit, configured to acquire part-time request information of a first target person, wherein the part-time request information includes a part-time role to be taken by the first target person and a first target department to which the part-time role belongs; and acquire an organizational structure of a target company to which the first target person belongs, wherein the organizational structure includes N departments of the target company, the N departments have a tree-like hierarchy, and N is an integer greater than or equal to 2;

a processing unit, configured to determine whether a department identical to the first target department exists in the N departments; if it is determined that a first department in the N departments is identical to the first target department, assign the part-time role to the first department, and update the organizational structure; or if it is determined that no department identical to the first target department exists in the N departments, determine a superior department of the first target department; and add, based on the superior department, the first target department as a part-time department to the organizational structure, and update the organizational structure; and

an output unit, configured to output an updated organizational structure.

In a possible design, the organizational structure further includes a personnel review relationship corresponding to any department in the organizational structure, the personnel review relationship is an approval relationship or assessment relationship in the any department, and the personnel review relationship includes a reviewer role and a reviewee role in a review process node; and

the processing unit is specifically configured to plan a role of the part-time role in the personnel review relationship corresponding to the first department, and update the organizational structure.

In a possible design, the processing unit is further configured to: define the part-time role as a reviewer role in the personnel review relationship corresponding to the first target department.

In a possible design, any department in M departments is an inherent main department or part-time department in the organizational structure of the target company, the M departments include the N departments, or include the N departments and the first target department;

the receiving unit is further configured to: acquire review request information sent by a second target person in the target company, wherein the review request information is approval request information or assessment information, and the review request information includes identification information of the second target person; and acquire a personnel review relationship corresponding to the M departments; and

the processing unit is further configured to: determine, based on the personnel review relationship corresponding to the M departments, L departments to which the second target person belongs and respective reviewer roles in the L departments, where L is an integer greater than or equal to 1; traverse a tree-like hierarchy among the M departments, and determine respective upper-level departments corresponding to the L departments and respective reviewer roles in the upper-level departments; sort, based on a hierarchical relationship between the L departments and the upper-level departments, respective reviewer roles corresponding to the L departments and the respective reviewer roles in the upper-level departments in an ascending hierarchical order to obtain a hierarchical reviewer role sorting relationship; and review the review request information level by level based on the hierarchical reviewer role sorting relationship.

In a possible design, the processing unit is further configured to:

if reviewer roles of any level in the hierarchical reviewer role sorting relationship include at least two identical reviewer roles, reserve one of the at least two reviewer roles in a review process, and delete the rest of the at least two reviewer roles.

In a possible design, the receiving unit is further configured to: acquire assistance request information of a second target department in the M departments, wherein the assistance request information includes the number of assistants required by the second target department; and

The processing unit is further configured to: determine respective surplus labor of departments other than the second target department in the M departments to obtain X third target persons, where X is an integer greater than or equal to 1; and pick up third target persons with the number of assistants required from the X third target persons to serve as the assistants of the second target department.

In a possible design, the processing unit is further configured to: if the X third target persons include a plurality of identical third target persons, reserve one of the plurality of third target persons, and delete the rest of the plurality of third target persons.

According to a third aspect, the embodiments of the present invention further provide an intelligent management device, including: at least one memory and at least one processor;

the at least one memory is configured to store one or more programs; and

the one or more programs, when executed by the at least one processor, implement the method involved in any possible design of the first aspect.

According to a fourth aspect, the embodiments of the present invention further provide a computer-readable storage medium, storing at least one program, wherein the at least one program, when executed by a processor, implements the method involved in any possible design of the first aspect.

For the beneficial technical effects of the second aspect to the fourth aspect, refer to the beneficial technical effect of the first aspect. Details are not described herein again.

For a better understanding and implementation, the present invention will be described in detail below with reference to the accompanying drawings.

### BRIEF DESCRIPTION OF THE DRAWINGS

FIG. 1 is a schematic diagram of an organizational structure in the prior art;

FIG. 2 is a schematic flowchart of an intelligent management method for an organizational structure according to an embodiment of the present invention;

FIG. 3A is a schematic diagram of an organizational structure of a target company before update according to an embodiment of the present invention;

FIG. 3B is a schematic diagram of an updated organizational structure of a target company according to an embodiment of the present invention;

FIG. 3C is a schematic diagram of another updated organizational structure of a target company according to an embodiment of the present invention;

FIG. 3D is a schematic diagram of further another updated organizational structure of a target company according to an embodiment of the present invention;

FIG. 4 is a schematic diagram of an organizational structure of a target company according to an embodiment of the present invention;

FIG. 5 is a schematic flowchart of another intelligent management method for an organizational structure according to an embodiment of the present invention;

FIG. 6 is a schematic flowchart of further another intelligent management method for an organizational structure according to an embodiment of the present invention;

FIG. 7 is a schematic architecture diagram of an intelligent management system according to an embodiment of the present invention; and

FIG. 8 is a schematic structural diagram of an intelligent management device according to an embodiment of the present invention.

### DETAILED DESCRIPTION OF THE EMBODIMENTS

As shown in FIG. 1, in the conventional organizational structure management, when people work together across organizations, each organization is relatively independent in terms of approval and assessment relationships. For example, a department A and a department B are independent of each other in terms of approval and assessment relationships. This leads to the problem of lack of interoperability between organizations, which causes difficulty in flat management of organization staff and fails to effectively realize office automation management.

On this basis, embodiments of the present invention provide an intelligent management method and system for an organizational structure, and a medium, to solve the problem of lack of interoperability between organizations, so as to implement flat management of organization staff and effectively realize office automation management.

The technical solution provided by the embodiments of the present invention will be described in detail below in conjunction with the accompanying drawings.

The implementations described in the following exemplary embodiments do not represent all implementations consistent with the present invention. On the contrary, they are merely examples of implementations consistent with some aspects of the present invention.

The terms used in the present invention are merely to describe the specific embodiments, instead of limiting the present invention. The singular forms “one”, “the”, and “this” used in this disclosure are also intended to cover plural forms unless their meanings are otherwise clearly indicated in the context. It should also be understood that the term “and/or” used herein refers to and includes any of one or more of the associated listed items or all possible combinations.

Unless otherwise specified, the ordinal words such as “first” to “third” in the embodiments of the present invention are used for differentiating multiple objects, but are not intended to limit the order, sequence, priority or importance of the multiple objects.

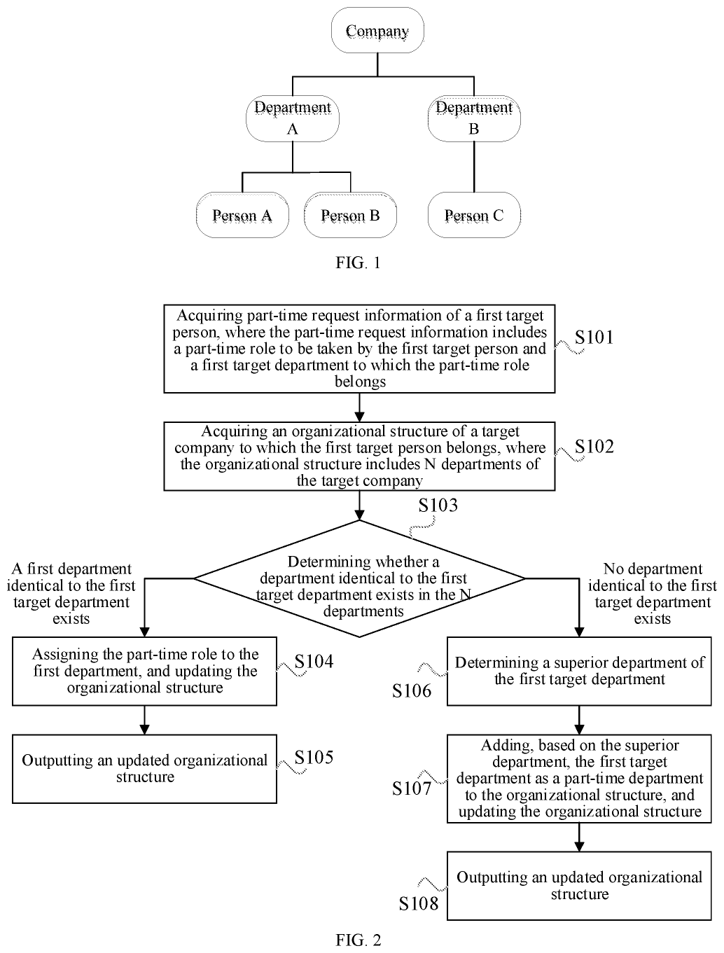

Referring to FIG. 2, an intelligent management method for an organizational structure provided by the embodiments of the present invention may include the following steps:

S101: Acquire part-time request information of a first target person, wherein the part-time request information includes a part-time role to be taken by the first target person and a first target department to which the part-time role belongs.

In some embodiments, when the target company needs to schedule a first target person to take a role in a first target department part-time, part-time request information of the first target person may be sent to an intelligent management system (a system for managing an organizational structure of the target company). Correspondingly, the intelligent management system may acquire the part-time request information of the first target person.

It should be noted that before the part-time request information of the first target person is acquired, the first target person may only take a main job role, or may take a plurality of position roles part-time, where one position role in the plurality of position roles may be the main job role of the first target person, and other position roles may be part-time roles of the first target person. For example, the plurality of position roles taken by the first target person in the target company include 3 position roles, which are a position-A role, a position-B role, and a position-C role. In this case, the main job role of the first target person may be the position-A role, and the part-time roles may be the position-B role and the position-C role. It should be noted that the 3 position roles may belong to different departments or the same department.

S102: Acquire an organizational structure of a target company to which the first target person belongs, wherein the organizational structure includes N departments of the target company.

In some embodiments, the intelligent management system may store the organizational structure of the target company in advance, or acquire the organizational structure of the target company from a server of the target company after acquiring the part-time request information of the first target person. Specifically, the target company may send the organizational structure thereof to the intelligent management system.

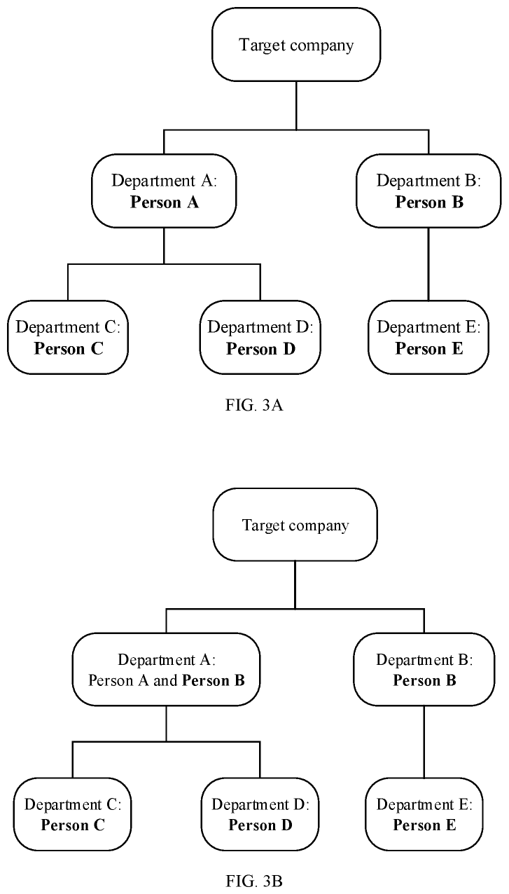

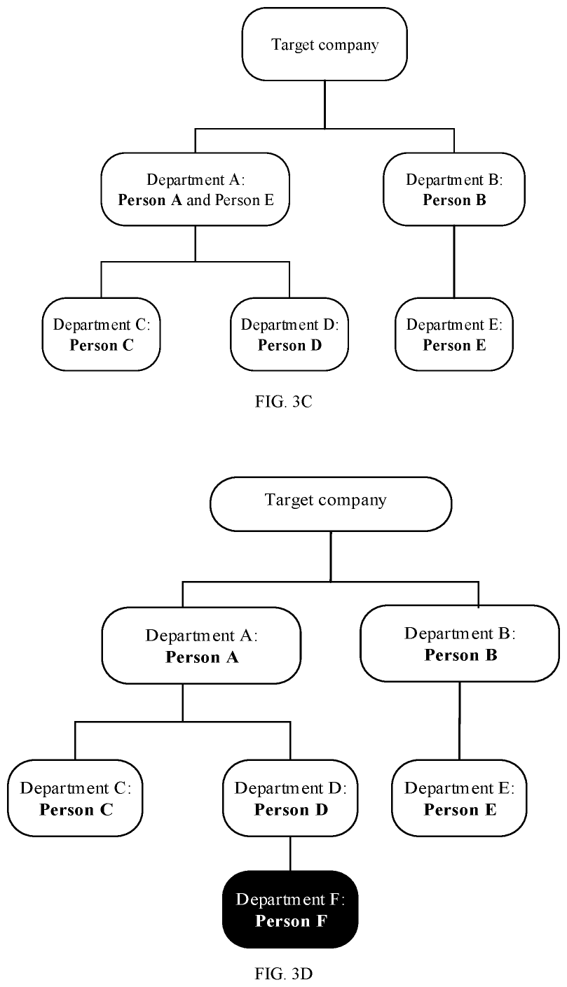

In some embodiments, the N departments have a tree-like hierarchy, where N is an integer greater than or equal to 2. For example, the N departments include 5 departments, which are a department A, a department B, a department C, a department D, and a department E. The hierarchical structure among the N departments may be as shown in FIGS. 3A-3D.

S103: Determine whether a department identical to the first target department exists in the N departments. If it is determined that a first department in the N departments is identical to the first target department, steps S104 to S105 are performed; if no department in the N departments is identical to the first target department, steps S106 to S108 are performed.

In some embodiments, the intelligent management system may determine whether a department identical to the first target department exists in the N departments, obtain a corresponding determining result, and perform corresponding processing based on the determining result. For example, if the determining result is that the first department in the N departments is identical to the first target department, steps S104 to S105 can be performed; if the determining result is that no department in the N departments is identical to the first target department, steps S106 to S108 can be performed, thereby flexibly adjusting the organizational structure of the target company and facilitating flat management of department staff of the target company.

S104: Assign the part-time role to the first department and update the organizational structure.

In some embodiments, the organizational structure further includes a personnel review relationship corresponding to any department in the organizational structure. The personnel review relationship may be an approval relationship or assessment relationship in any department. The personnel review relationship includes a reviewer role and a reviewee role in a review process node. It should be noted that the reviewer role may be an approver role or an assessor role, and the reviewee role may be an approved role or an assessed role.

For example, the reviewer role may be a supervisor role, and the reviewee role may be an employee role.

In a specific implementation process, a role of the part-time role in the personnel review relationship corresponding to the first department may be planned, and the organizational structure is updated.

In an example, as shown in FIG. 3A and FIG. 3B, the department A is the first department, and the first target person is a person B in the department B. If a person A (which is in bold to represent the reviewer role) in the department A is on leave and cannot perform a review, and when the person B in the department B is temporarily scheduled to take a part-time job in the department A, the part-time role of the person B may be planned to be the reviewer role in the personnel review relationship corresponding to the department A. At this point, the reviewer role of the person B in the department B can be ensured to remain unchanged.

In another example, as shown in FIG. 3A and FIG. 3C, the department A is the first department, and the first target person is a person E in the department E. If the department A holds a corresponding activity and is in lack of corresponding assistants while the person E in the department E has surplus labor, when the person E is temporarily scheduled from the department E to the department A to take a part-time job, the part-time role of the person E may be planned to be the reviewee role in the personnel review relationship corresponding to the department A.

S105: Output an updated organizational structure.

In some embodiments, the first department in the N departments is identical to the first target department; in this case, the department structure in the updated organizational structure is identical to the department structure in the organizational structure before the update, and only the personnel review relationship in the first department has changed. That is, the updated organizational structure includes the N departments.

In the specific implementation process, the updated organizational structure may be outputted in a visual manner, so that the updated organizational structure can be checked conveniently.

S106: Determine a superior department of the first target department.

In some embodiments, the part-time request information of the first target person may further include a superior department of the first target department. The intelligent management system may determine the superior department of the first target department according to the part-time request information.

It should be noted that the superior department of the first target department may be the first target department itself. In this case, it may be considered by default that the first target department has no substantial superior department; alternatively, the superior department of the first target department may be another department.

S107: Add, based the superior department, the first target department as a part-time department to the organizational structure, and update the organizational structure.

In some embodiments, the intelligent management system may define the part-time role as a reviewer role in the personnel review relationship corresponding to the first target department. For example, because the first target department does not exist in the organizational structure, the first target department only includes the first target person. In this case, the part-time role of the first target person may be defined as the reviewer role in the personnel review relationship corresponding to the first target department. After that, the intelligent management system may mark the first target department as a part-time department, then add the first target department to the organizational structure, and update the organizational structure.

For example, as shown in FIG. 3A and FIG. 3D, the first target department is a department F, the first target person is a person F, and the superior department of the first target department is the department D. The intelligent management system may define the person F as a reviewer role in a personnel review relationship corresponding to the department F, mark the department F as a part-time department, add the department F to subordinate departments of the department D, and update the organizational structure.

S108: Output an updated organizational structure.

In some embodiments, because no department in the N departments is identical to the first target department, the department structure in the updated organizational structure has changed compared with the department structure in the organizational structure before the update, that is, the first target department is added. That is, the updated organizational structure includes the N departments and the first target department.

In the specific implementation process, the updated organizational structure may be outputted in a visual manner, so that the updated organizational structure can be checked conveniently.

It can be learned from the above description that, in the technical solution provided by the embodiments of the present invention, by adding part-time information (part-time role and part-time department) to an organizational structure of a target company, department combinations in the organizational structure are more diverse and visible, and the relationship between staff and departments in the organizational structure is clear and visible, which facilitates information management of the organizational structure, and the organizational structure can be adjusted flexibly, so that during scheduling of department staff, cross-department review (approval and/or assessment) can be implemented, to facilitate flat management of staff in various departments, thereby effectively realizing office automation management. In addition, when there is no expert department system in the target company, a temporary system can be established by creating a part-time department, so that expert staff can take part-time position roles of multiple departments to provide guidance.

It should be noted that the management for the organizational structure not only includes the update adjustment of the organizational structure but also includes a review of each review process in the organizational structure.

In an applicable scenario provided by the embodiments of the present invention, as shown in FIG. 1 to FIG. 5, the intelligent management method for an organizational structure provided by the embodiments of the present invention further includes the following steps:

S201: Acquire review request information sent by a second target person in the target company.

In some embodiments, the review request information may include approval request information or assessment information. The review request information includes identification information of the second target person. The identification information may be an employee number of the second target person or other information that can uniquely identify the second target person, which is not limited in the embodiments of the present invention.

For example, when the second target person needs to approve a project (or approve other items), the review request information may be submitted to the intelligent management system. Correspondingly, the intelligent management system may acquire the review request information.

S202: Acquire a personnel review relationship corresponding to M departments.

In some embodiments, any department in the M departments is an inherent main department or part-time department in the organizational structure of the target company. The M departments include the N departments, or include the N departments and the first target department.

In a specific implementation process, the personnel review relationship corresponding to the M departments may be stored by the intelligent management system in advance, or acquired by the intelligent management system from the server of the target company, or sent by the server to the intelligent management system, which is not limited in the embodiments of the present invention.

S203: Determine, based on the personnel review relationship corresponding to the M departments, L departments to which the second target person belongs and respective reviewer roles in the L departments, where L is an integer greater than or equal to 1.

In some embodiments, the L departments are some departments in the M departments.

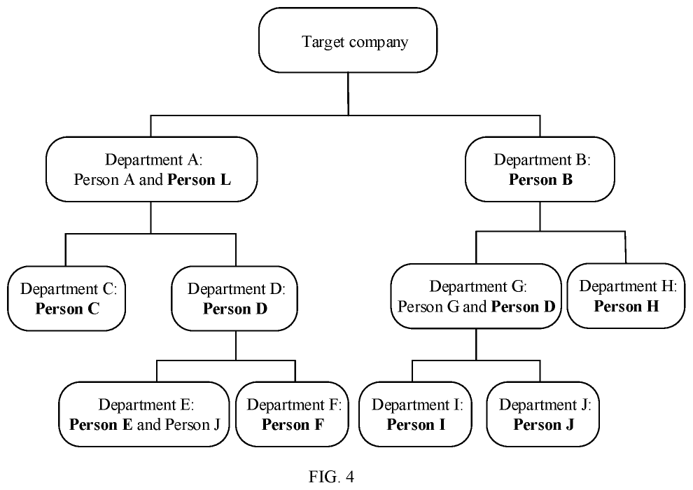

For example, the structure of the M departments is as shown in FIG. 4, and the second target person is a person J. It may be determined, based on the personnel review relationship corresponding to the M departments, that the L departments corresponding to the person J include a department E and a department J, a reviewer role of the department E is a person E, and a reviewer role of the department J is the person J.

S204: Traverse a tree-like hierarchy among the M departments, and determine respective upper-level departments corresponding to the L departments and respective reviewer roles in the upper-level departments.

For example, the structure of the M departments is as shown in FIG. 4, and the upper-level departments of the department E include a department D and a department A. A reviewer role of the department D is a person D, and a reviewer role of the department A is a person L. The upper-level departments of the department J include a department G and a department B. A reviewer role of the department G is a person D, and a reviewer role of the department B is a person B.

S205: Sort, based on a hierarchical relationship between the L departments and the upper-level departments, respective reviewer roles corresponding to the L departments and the respective reviewer roles in the upper-level departments in an ascending hierarchical order to obtain a hierarchical reviewer role sorting relationship.

For example, the structure of the M departments is as shown in FIG. 4, the hierarchical reviewer role sorting relationship corresponding to the person J (i.e., the second target person) is as follows: third-level reviewer roles are the person E and the person J, second-level reviewer roles are the person D and the person D, and first-level reviewer roles are the person L and the person B.

S206: Review the review request information level by level based on the hierarchical reviewer role sorting relationship.

For example, the review request information may be first reviewed by the third-level reviewer roles, and after passing the review by the third-level reviewer role, the review request information is reviewed by the second-level reviewers. After passing the review by the second-level reviewer roles, the review request information is finally reviewed by the first-level reviewer roles.

In some embodiments, to simplify the review process, if reviewer roles of any level in the hierarchical reviewer role sorting relationship include at least two identical reviewer roles, one of the at least two reviewer roles may be reserved, and the rest of the at least two reviewer roles may be deleted.

For example, as shown in FIG. 4, there is the same reviewer, i.e., the person D, in the second-level reviewer roles corresponding to the person J, and one reviewer role of the person D may be reserved. For example, in the review process, the reviewer role of the person D in the department D may be reserved, and the reviewer role in the department G may be deleted; or the reviewer role in the department G is reserved, and the reviewer role in the department D is deleted. It should be understood that the deletion of the reviewer role herein does not involve deletion of the reviewer role in the organizational structure.

In the embodiments of the present invention, reviewer roles of different levels corresponding to the second target person are sorted hierarchically and perform reviewing level by level, which facilitates flat management of the review process of department staff, thereby effectively realizing office automation management.

It should be noted that the management of the organizational structure may further include temporary scheduling management of department staff, which does not involve the scheduling or change of the position role. For example, in another applicable scenario provided by the embodiments of the present invention, as shown in FIG. 1 to FIG. 6, the intelligent management method for an organizational structure provided by the embodiments of the present invention further includes the following steps:

S301: Acquire assistance request information of a second target department in the M departments, wherein the assistance request information includes the number of assistants required by the second target department.

For example, as shown in FIG. 4, if the department D holds some activities temporarily and is in lack of staff, assistance request information may be submitted to the intelligent management system. Correspondingly, the intelligent management system acquires the assistance request information.

S302: Determine respective surplus labor of departments other than second target department in the M departments to obtain X third target persons.

In some embodiments, X is an integer greater than or equal to 1.

In some embodiments, after acquiring the assistance request information, the intelligent management system may determine respective surplus labor of departments other than second target department in the M departments to obtain X third target persons.

For example, the intelligent management system may determine the surplus labor of the department A, the department B, the department C, the department E, the department F, the department G, the department H, the department I, and the department J to obtain X third target persons.

S303: Pick up third target persons with the number of assistants required from the X third target persons to serve as the assistants of the second target department.

In some embodiments, to simplify the personnel pickup process, if the X third target persons include a plurality of identical third target persons, the intelligent management system may reserve one of the plurality of third target persons, and delete the rest of the plurality of third target persons.

In the embodiments of the present invention, surplus labor in a department can be lent to other departments in the form of part-time labor, and department staff can be scheduled flexibly, which can improve the utilization of staff and effectively realize office automation management.

Based on the same inventive concept, the embodiments of the present invention further provide an intelligent management device. As shown in FIG. 7, an intelligent management system 400 may include:

a receiving unit 401, configured to acquire part-time request information of a first target person, wherein the part-time request information includes a part-time role to be taken by the first target person and a first target department to which the part-time role belongs; and acquire an organizational structure of a target company to which the first target person belongs, wherein the organizational structure includes N departments of the target company, the N departments have a tree-like hierarchy, and N is an integer greater than or equal to 2;

a processing unit 402, configured to determine whether a department identical to the first target department exists in the N departments; if it is determined that a first department in the N departments is identical to the first target department, assign the part-time role to the first department, and update the organizational structure; or if it is determined that no department identical to the first target department exists in the N departments, determine a superior department of the first target department; and add, based on the superior department, the first target department as a part-time department to the organizational structure, and update the organizational structure; and

an output unit 403, configured to output an updated organizational structure.

In a possible design, the organizational structure further includes a personnel review relationship corresponding to any department in the organizational structure, the personnel review relationship is an approval relationship or assessment relationship in the any department, and the personnel review relationship includes a reviewer role and a reviewee role in a review process node; and

the processing unit 402 is specifically configured to plan a role of the part-time role in the personnel review relationship corresponding to the first department, and update the organizational structure.

In a possible design, the processing unit 402 is further configured to: define the part-time role as a reviewer role in the personnel review relationship corresponding to the first target department.

In a possible design, any department in M departments is an inherent main department or part-time department in the organizational structure of the target company, the M departments include the N departments, or include the N departments and the first target department;

the receiving unit 401 is further configured to: acquire review request information sent by a second target person in the target company, wherein the review request information is approval request information or assessment information, and the review request information includes identification information of the second target person; and acquire a personnel review relationship corresponding to the M departments; and

the processing unit 402 is further configured to: determine, based on the personnel review relationship corresponding to the M departments, L departments to which the second target person belongs and respective reviewer roles in the L departments, where L is an integer greater than or equal to 1; traverse a tree-like hierarchy among the M departments, and determine respective upper-level departments corresponding to the L departments and respective reviewer roles in the upper-level departments; sort, based on a hierarchical relationship between the L departments and the upper-level departments, respective reviewer roles corresponding to the L departments and the respective reviewer roles in the upper-level departments in an ascending hierarchical order to obtain a hierarchical reviewer role sorting relationship; and review the review request information level by level based on the hierarchical reviewer role sorting relationship.

In a possible design, the processing unit 402 is further configured to:

if reviewer roles of any level in the hierarchical reviewer role sorting relationship include at least two identical reviewer roles, reserve one of the at least two reviewer roles in a review process, and delete the rest of the at least two reviewer roles.

In a possible design, the receiving unit 401 is further configured to: acquire assistance request information of a second target department in the M departments, wherein the assistance request information includes the number of assistants required by the second target department; and

the processing unit 402 is further configured to: determine respective surplus labor of departments other than the second target department in the M departments to obtain X third target persons, where X is an integer greater than or equal to 1; and pick up third target persons with the number of assistants required from the X third target persons to serve as the assistants of the second target department.

In a possible design, the processing unit 402 is further configured to: if the X third target persons include a plurality of identical third target persons, reserve one of the plurality of third target persons, and delete the rest of the plurality of third target persons.

It should be noted that the receiving unit 401, the processing unit 402, and the output unit 403 may be integrated on the same device (such as the server of the target company), or may be independently disposed on different devices, which is not limited in the embodiments of the present invention.

The intelligent management system 400 in this embodiment of the present invention is an invention based on the same concept as the intelligent management method for an organizational structure shown in FIG. 2 and FIG. 5 to FIG. 6. Those skilled in the art can clearly understand the implementation process of the intelligent management system 400 of this embodiment. Therefore, for the brevity of the specification, details are not described herein again.

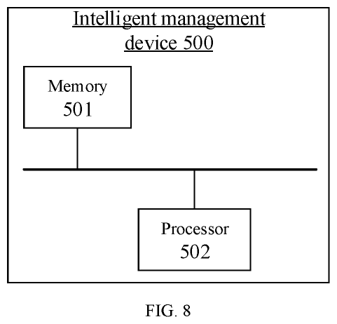

Based on the same inventive concept, the embodiments of the present invention further provide an intelligent management device. As shown in FIG. 8, an intelligent management device 500 may include: at least one memory 501 and at least one processor 502.

The at least one memory 501 is configured to store one or more programs.

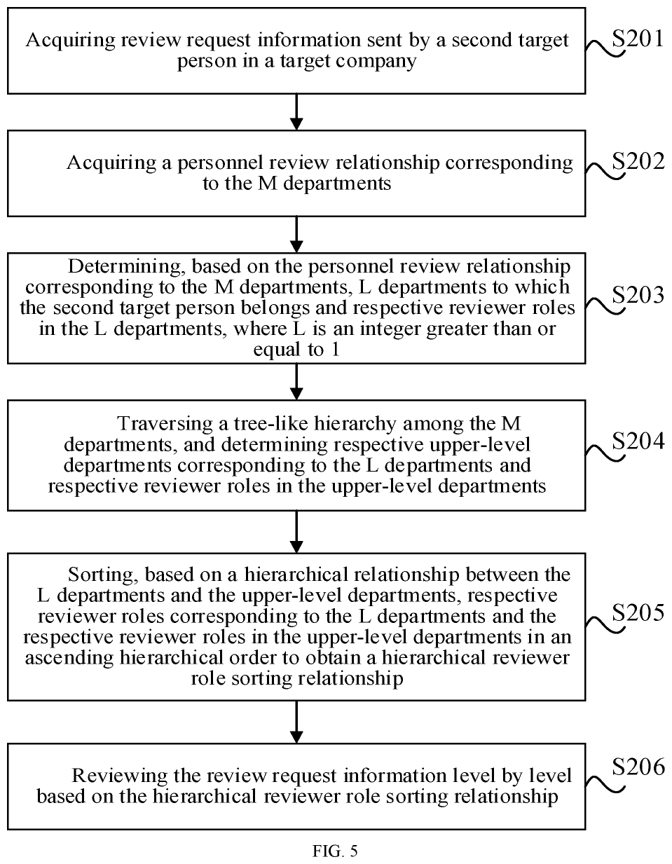

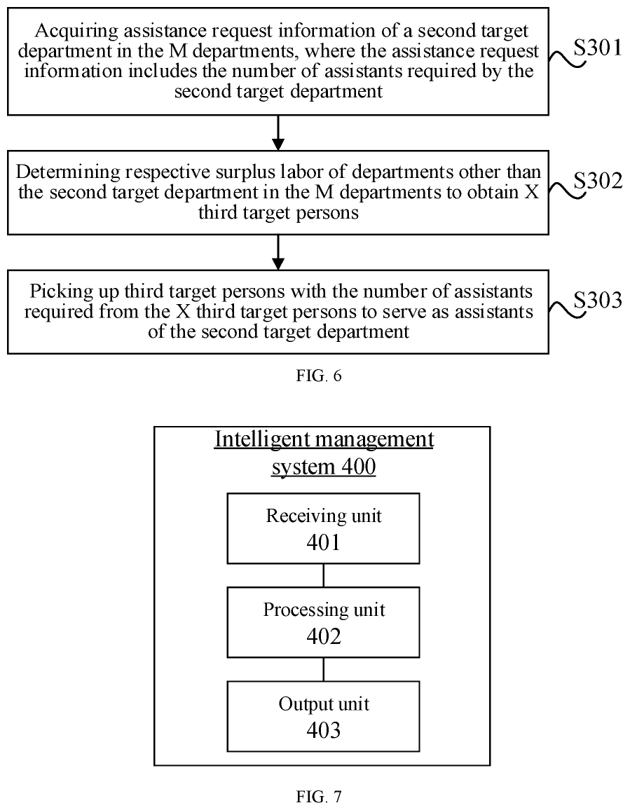

The one or more programs, when executed by the at least one processor 502, implement the intelligent management method for an organizational structure shown in FIG. 2, FIG. 5, and FIG. 6.

Optionally, the intelligent management device 500 may include a communication interface. The communication interface is configured to perform communication and data interactive transmission with an external device.

It should be noted that the memory 501 may include a high-speed RAM, and my further include a nonvolatile memory, such as at least one magnetic memory.

In a specific implementation process, if the memory 501, the processor 502, and the communication interface are integrated on the same chip, the memory 501, the processor 502 and the communication interface can communicate with each other through internal interfaces. If the memory 501, the processor 502, and the communication interface are implemented independently, the memory 501, the processor 502 and the communication interface can be connected to each other and communicate with each other through a bus.

Based on the same inventive concept, the embodiments of the present invention further provide a computer-readable storage medium, storing at least one program, wherein the at least one program, when executed by a processor, implements the intelligent management method for an organizational structure shown in FIG. 1.

It should be understood that the computer-readable storage medium may be any data storage device capable of storing data or programs, and the data or programs may be subsequently read by a computer system. Examples of the computer-readable storage medium include: a read-only memory, a random-access memory, a CD-ROM, an HDD, a DVD, a magnetic tape, an optical data storage device, and the like.

The computer-readable storage medium may further be distributed in a computer system coupled to a network, so that computer-readable code is stored and executed in a distributed manner.

The program code contained in the computer-readable storage medium may be transmitted using any suitable medium, including but not limited to: wireless, wire, optical fiber, radio frequency (RF), or any suitable combination thereof.

The above-mentioned examples only express several implementations of the present invention, and the descriptions thereof are relatively specific and detailed, but they should not be thereby interpreted as limiting the scope of the present invention. It should be noted that those of ordinary skill in the art can further make several variations and improvements without departing from the idea of the present invention, but such variations and improvements shall all fall within the protection scope of the present invention.

What is claimed is:

1. An intelligent management method for an organizational structure, comprising:
acquiring part-time request information of a first target person, wherein the part-time request information comprises a part-time role to be taken by the first target person and a first target department, wherein the part-time role belongs to the first target department;
acquiring an organizational structure of a target company, wherein the first target person belongs to the target company, wherein the organizational structure comprises N departments of the target company, the N departments have a first tree-like hierarchy, and N is an integer greater than or equal to 2;
determining whether a department identical to the first target department exists in the N departments;
when a first department in the N departments is identical to the first target department, assigning the part-time role to the first department, and updating the organizational structure; or when no department identical to the first target department exists in the N departments, determining a superior department of the first target department; and adding, based on the superior department, the first target department as a part-time department to the organizational structure, and updating the organizational structure; and
outputting an updated organizational structure.

2. The intelligent management method according to claim 1, wherein the organizational structure further comprises a personnel review relationship corresponding to any department in the organizational structure, the personnel review relationship is an approval relationship or assessment relationship in the any department, and the personnel review relationship comprises a reviewer role and a reviewee role in a review process node;
the step of assigning the part-time role to the first department and updating the organizational structure comprises: planning a role of the part-time role in the personnel review relationship corresponding to the first department, and updating the organizational structure; and
before the step of adding, based on the superior department, the first target department as the part-time department to the organizational structure, and updating the organizational structure, the intelligent management method further comprises: defining the part-time role as a reviewer role in the personnel review relationship corresponding to the first target department.

3. The intelligent management method according to claim 2, wherein any department in M departments is an inherent main department or part-time department in the organizational structure of the target company; wherein the M departments comprise the N departments, or comprise the N departments and the first target department; and the intelligent management method further comprises:
acquiring review request information sent by a second target person in the target company, wherein the review request information is approval request information or assessment information, and the review request information comprises identification information of the second target person;
acquiring a personnel review relationship corresponding to the M departments;
determining, based on the personnel review relationship corresponding to the M departments, L departments and respective reviewer roles in the L departments, wherein the second target person belongs to the L departments, wherein L is an integer greater than or equal to 1;
traversing a second tree-like hierarchy among the M departments, and determining respective upper-level departments corresponding to the L departments and respective reviewer roles in the upper-level departments;
sorting, based on a hierarchical relationship between the L departments and the upper-level departments, respective reviewer roles corresponding to the L departments and the respective reviewer roles in the upper-level departments in an ascending hierarchical order to obtain a hierarchical reviewer role sorting relationship; and
reviewing the review request information level by level based on the hierarchical reviewer role sorting relationship.

4. The intelligent management method according to claim 3, wherein before the step of reviewing the review request information level by level based on the hierarchical reviewer role sorting relationship, the intelligent management method further comprises:
when reviewer roles of any level in the hierarchical reviewer role sorting relationship comprise at least two identical reviewer roles, reserving one of the at least two identical reviewer roles in a review process, and deleting the rest of the at least two identical reviewer roles.

5. The intelligent management method according to claim 3, further comprising:
acquiring assistance request information of a second target department in the M departments, wherein the assistance request information comprises a number of assistants required by the second target department;
determining respective surplus labor of departments other than the second target department in the M departments to obtain X third target persons, wherein X is an integer greater than or equal to 1; and
picking up third target persons with the number of assistants required from the X third target persons to serve as the assistants of the second target department.

6. The intelligent management method according to claim 5, wherein before the step of picking up the third target persons with the number of assistants required from the X third target persons to serve as the assistants of the second target department, the intelligent management method further comprises:
when the X third target persons comprise a plurality of identical third target persons, reserving one of the plurality of identical third target persons, and deleting the rest of the plurality of identical third target persons.

7. An intelligent management system, comprising:
a receiving unit, configured to acquire part-time request information of a first target person, wherein the part-time request information comprises a part-time role to be taken by the first target person and a first target department, wherein the part-time role belongs to the first target department; and acquire an organizational structure of a target company, wherein the first target person belongs to the target company, wherein the organizational structure comprises N departments of the target company, the N departments have a tree-like hierarchy, and N is an integer greater than or equal to 2;
a processing unit, configured to determine whether a department identical to the first target department exists in the N departments; when a first department in the N departments is identical to the first target department, assign the part-time role to the first department, and update the organizational structure; or when no department identical to the first target department exists in the N departments, determine a superior department of the first target department; and add, based on the superior department, the first target department as a part-time department to the organizational structure, and update the organizational structure; and
an output unit, configured to output an updated organizational structure.
